(19) United States
(12) Patent Application Publication
(10) Pub. No.: US 2026/0029424 A1
(43) Pub. Date: Jan. 29, 2026

(54) METHOD, SYSTEM, AND MEDIUM FOR ASSESSING BRIDGE DAMAGE TRIGGERED BY SHIP IMPACT

(71) Applicants: Hohai University, Nanjing (CN); Chuzhou university, Chuzhou (CN)

(72) Inventors: Maosen Cao, Nanjing (CN); Chunhui Xie, Nanjing (CN); Wanwen Zhong, Nanjing (CN); Yufeng Zhang, Nanjing (CN); Jiayi Peng, Nanjing (CN); Drahomír Novak, Brno (CZ); Li Cui, Nanjing (CN); Jinwen Huang, Nanjing (CN)

(73) Assignees: Hohai University, Nanjing (CN); Chuzhou University, Chuzhou (CN)

(21) Appl. No.: 19/308,231

(22) Filed: Aug. 23, 2025

(30) Foreign Application Priority Data
Nov. 8, 2024 (CN) 202411591863.0

(51) Int. Cl. G01P 15/18; G01M 5/00

(52) U.S. Cl. CPC G01P 15/18; G01M 5/0008

(57) ABSTRACT

The present disclosure provides a method, a system, and a medium for maintaining bridge structures susceptible to damage triggered by ship impact, and relates to the field of bridge health monitoring technology. If ship-bridge collision damage occurs, time-frequency coherence degradation factors at different positions of a time-series matrix, allows determination of an impact damage position and a damage degree based on a convex maximum point in the trajectory curve of the time-frequency coherence degradation factors. This method can effectively separate the influence of environmental factors and provide a fundamental methodological basis for establishing ship-bridge collision damage assessment technology.

### TECHNICAL FIELD

The present disclosure relates to the field of bridge health monitoring technology, particularly to a method, a system, and a medium for assessing bridge damage triggered by ship impact, and a method of maintaining bridges that are susceptible to ship impacts.

### BACKGROUND

Ship-bridge collision occurs intermittently due to complex climatic conditions and human factors. In bridge accidents, cracks are prone to form in the local fracture zone damaged by ship impact. If hidden cracks are not discovered in time, they can pose a potential threat to bridge safety. Currently, sensors typically acquire acceleration response signals. However, due to environmental factors, distinguishing the causes of abnormal signal characteristics is difficult, and the true damage characteristics are intertwined with complex environmental influences, making them challenging to identify effectively. Therefore, effectively eliminating environmental factors is crucial for ship-bridge collision damage identification research.

There is currently a significant lack of research on the identification of localized hidden cracks in bridges triggered by ship impacts. Existing methods are mostly limited to assessing the effects of ship-impact damage on bridges globally through global indicators such as pier-top displacement and rotation angle, and determining whether a ship impact has caused damage to the bridge, while lacking an effective detection method for locally identifying hidden cracks after the ship-bridge collision, accurately capturing their dynamic characteristics, and locating and identifying the position and severity of the cracks.

### SUMMARY

In order to solve the above problems, the present disclosure provides a method for assessing bridge damage triggered by ship impact. This method effectively separates environmental variables and achieves fast and accurate extraction of bridge dynamic information, which breaks through the limitation that the existing impact damage identification method cannot distinguish whether the damage characteristics are caused by actual structural damage.

In order to achieve the above objective, the present disclosure provides the following technical solution.

A method for assessing bridge damage triggered by ship impact, including the following steps:
acquiring acceleration response signal arrays at different heights and positions of bridge piers impacted by ships, and generating a time-series matrix of acceleration response signals based on the acceleration response signal arrays;
plotting time-frequency coherence spectra under different basis functions according to the time-series matrix, and obtaining coherence spectral entropy; based on an information entropy principle, determining an optimal basis function by measuring an information volume of time-frequency coherence spectra in different basis function domains according to the coherence spectral entropy;
obtaining local correlation coefficients of the time-series matrix in the time-frequency domain under the optimal basis function, and plotting the time-frequency coherence spectra; evaluating a correlation dependence degree between time series based on the local correlation coefficients and time-frequency coherence spectra to determine whether ship-bridge collision damage has occurred; and
if the ship-bridge collision damage has occurred, calculating time-frequency coherence degradation factors at different positions of the time-series matrix, and plotting a trajectory curve of time-frequency coherence degradation factors; determining an impact damage position and a damage degree based on a convex maximum point in the trajectory curve of the time-frequency coherence degradation factors.

In some embodiments, the step of acquiring acceleration response signal arrays at different heights and positions of the bridge impacted by the ship includes the following steps:
mounting a wall-climbing robot according to characteristics of a target pier to be tested; each side of the wall-climbing robot facing the pier is provided with at least one acceleration sensor at equal intervals;
driving the wall-climbing robot to scan the pier by moving from top to bottom or from bottom to top, acquiring acceleration response signal arrays at different heights and positions of the pier through the acceleration sensors, and generating the time-series matrix.

In some embodiments, the time-series matrix is shown as follows:

$$H = [ \begin{matrix}{X}_{11} & ⋯ & {X}_{1 n} \\ ⋮ & ⋱ & ⋮ \\ {X}_{m 1} & ⋯ & {X}_{mn}\end{matrix} ] , {X}_{i j} = [ {x}_{1} {x}_{2} … {x}_{l} ]$$

where m is a total number of the set pier sensor layers, 1≤i≤m; n is a total number of array sensors in each layer, and 1≤j≤n; l is a total length of the acquire ion time series.

In some embodiments, the calculation of the local correlation coefficients is as follows:

$${R}^{2} ( a , b ) = \frac{{\vert S ( {W}^{{X}_{ij} {X}_{ik}} ( a , b ) ) \vert}^{2}}{[ {\vert S ( {W}^{{X}_{ij}} ( a , b ) ) \vert}^{2} \times {\vert S ( {W}^{{X}_{ik}} ( a , b ) ) \vert}^{2} ]}$$

in the formula, R²(a, b) is a time-frequency local correlation coefficient between two series, S is a smoothing operator, W^{X}^{ᵢⱼ}(a, b) and W^{X}^{ᵢₖ}(a, b) are wavelet coefficients of time series Xᵢⱼ and Xᵢₖ respectively, a is a scale factor of time-frequency transform, and b is a translation factor;
in the formula, when j≠k, W^{X}^{ᵢⱼ}^{X}^{ᵢₖ}(a, b) is a cross wavelet transform function for the time series Xᵢⱼ and Xᵢₖ, |W^{X}^{ᵢⱼ}^{X}^{ᵢₖ}(a, b)| represents its cross wavelet power; when j=k, W^{X}^{ᵢⱼ}^{X}^{ᵢₖ}(a, b) is an autocorrelation wavelet transform function for the time series Xᵢⱼ and Xᵢₖ, as shown in the following formula:

$${W}^{{X}_{ij} {X}_{ij}} ( a , b ) = {W}^{{X}_{ij}} ( a , b ) ( {W}^{{X}_{ik}} ( a , b ) ) *$$

in the formula, * is a complex conjugate.

In some embodiments, further including:
using the wavelet function as the basis function to calculate the undetermined wavelet coefficients W^{H}^{ᵢⱼ}(a, b) and W^{H}^{ᵢₖ}(a, b) in the time-frequency coherence values R²(a, b) between time series, as shown in the following formula:

$$W ( a , b ) = \frac{1}{\sqrt{a}} {\int }_{- ∞}^{+ ∞} {X}_{ij} ψ ( \frac{t - b}{a} ) dt$$

In the formula, ψ is a selected wavelet basis function.

In some embodiments, the calculation of the coherence spectral entropy includes the following steps:
dividing the time-frequency coherence spectra into N time-frequency planes with a same area, a number ζ_{w} of the correlation coefficients in each time-frequency plane passing the 95% significance test, (W=1, . . . , N), and the total number A of the whole time-frequency coherence spectra passing the 95% significance test, and normalizing each region to obtain:

$${q}_{w} = \frac{{ζ}_{w}}{A} , {\sum }_{w = 1}^{N} {q}_{i} = 1$$

based on a concept of information entropy, calculating the coherence spectral entropy H_{c} of the time-frequency coherence spectra by using the following formula:

$${H}_{c} = - {\sum }_{w = 1}^{N} {q}_{w} {log}_{2} ( {q}_{w} )$$

where the coherence spectral entropy H_{c} represents an intrinsic information quantity of the time-frequency coherence spectra, if the entropy value is greater, it indicates that the information quantity included in the time-frequency coherence spectra is greater, and an information value of the time-frequency coherence spectra is higher.

In some embodiments, the calculation of the time-frequency coherence degradation factor includes the following steps:
defining the time-frequency coherence degradation factor ∈ as follows:

$$∈ = ( {AWC}_{Intact} - {AWC}_{Input} ) / {AWC}_{Intact}$$

in the formula, AWC_{Intact} refers to a mean of the time-frequency coherence value of the undamaged structure in a certain time-frequency range; AWC_{Input} refers to a mean of the time-frequency coherence value of the structure to be tested in a certain time-frequency range.

In some embodiments, the step of determining the impact damage position and the damage degree based on the convex maximum point in the trajectory curve of the time-frequency coherence degradation factors, including the following steps:
based on the local correlation coefficient of the time-series matrix in the time-frequency domain, calculating a coherence of the time series at a 95% significance level by using a Monte Carlo method, and plotting the time-frequency coherence spectra;
wherein, the time-frequency coherence spectra fluctuate in a certain time-frequency range, and when a fluctuation degree cannot be restored to stability, it is determined that the ship-bridge collision damage occurs, the fluctuation degree is represented by a ratio of the number passing the 95% significance tests to the total number in the time-frequency coherence spectra;
based on variation characteristics of the time-frequency coherence degradation factor at the impact damage position, plotting the trajectory curve of the time-frequency coherence degradation factor, when bridge collision damage occurs, the time-frequency coherence degradation factor increases dramatically close to the impact damage position, while the degradation factor is nearly zero far from the impact damage position. It is considered that the layer where the convex maximum value of the curve is located is the impact damage position.

A system for assessing bridge damage triggered by ship impact, the system includes:
a processor;
a memory, a computer program executable on the processor is stored on the memory;
when the computer program is executed by the processor, the steps of a method for assessing bridge damage triggered by ship impact are implemented.

A computer-readable storage medium, a data processing program is stored on the computer-readable storage medium, when the data processing program is executed by the processor, the steps of a method for assessing bridge damage triggered by ship impact are implemented.

Beneficial effects of the present disclosure:
the present disclosure provides a method for assessing bridge damage triggered by ship impact. In this method, time-frequency coherence spectral entropy between signals of different basis functions is calculated based on a massive sensor signal acquired by the wall-climbing robot, the basis function is optimized, and the time-frequency coherence spectra in the time-frequency domain of the optimal basis function is subsequently plotted. In this method, environmental variables are effectively separated, and fast and accurate extraction of bridge dynamic information is achieved, which breaks through the limitation that the existing collision damage identification method cannot distinguish whether the damage characteristics are caused by actual structural damage. In the present disclosure, for variation characteristics of the time-frequency coherence degradation factor at the impact damage position, a time-frequency coherence degradation factor is established, and the position and the degree of the ship-bridge collision damage are identified by the trajectory curve of the time-frequency coherence degradation factor, which provides basic method support for establishing the ship-bridge collision damage assessment technology.

### BRIEF DESCRIPTION OF THE DRAWINGS

FIG. 1 is a flowchart of a method for assessing bridge damage triggered by ship impact according to an embodiment of the present disclosure;

FIG. 2 is a schematic diagram of a numerical simulation pier structure and a wall-climbing robot structure according to an embodiment of the present disclosure;

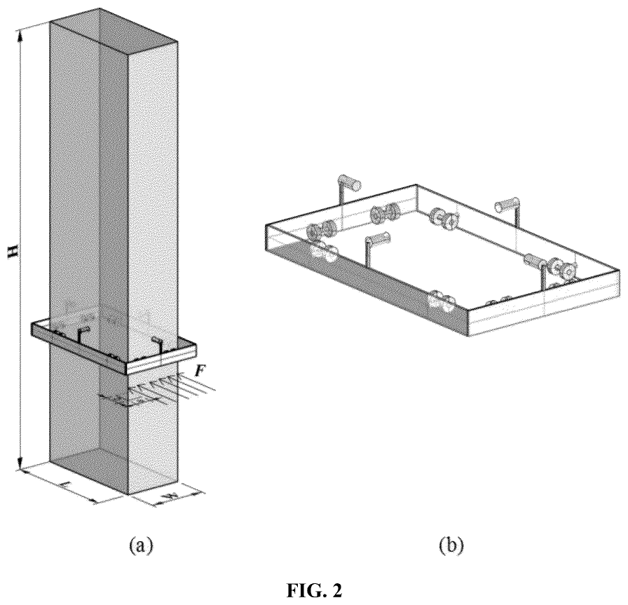

FIG. 3 is a schematic diagram of an acceleration signal acquisition node array according to an embodiment of the present disclosure, wherein FIG. 3(a) is an overall schematic of the acquisition node array, and FIG. 3(b) is a schematic of an acquisition node array of each layer;

FIG. 4 is time-frequency coherence spectra of different wavelet basis functions according to an embodiment of the present disclosure, wherein FIG. 4(a) is a Morlet wavelet basis function, FIG. 4(b) is a Dog wavelet basis function, and FIG. 4(c) is a 4th-order Paul wavelet basis function;

FIG. 5 is a schematic diagram of time-frequency coherence spectra of symmetrical nodes 2 and 4 according to an embodiment of the present disclosure, wherein FIG. 5(a) is an undamaged pier structure, and FIG. 5(b) is a damaged pier structure;

FIG. 6 shows trajectory curves of time-frequency coherence degradation factors between different nodes under different crack depths according to an embodiment of the present disclosure;

FIG. 7 shows trajectory curves of time-frequency coherence degradation factors for symmetrical nodes 2 and 4 at different array layers under different crack positions according to an embodiment of the present disclosure.

### DETAILED DESCRIPTION OF THE EMBODIMENTS

In order to make the objective, technical solution and advantages of the present disclosure clearer and more specific, the present disclosure will be further described in detail below with reference to accompanying drawings and embodiments. It should be understood that the specific embodiments described herein are merely illustrative of the present disclosure and are not intended to limit the present disclosure.

### Embodiment 1

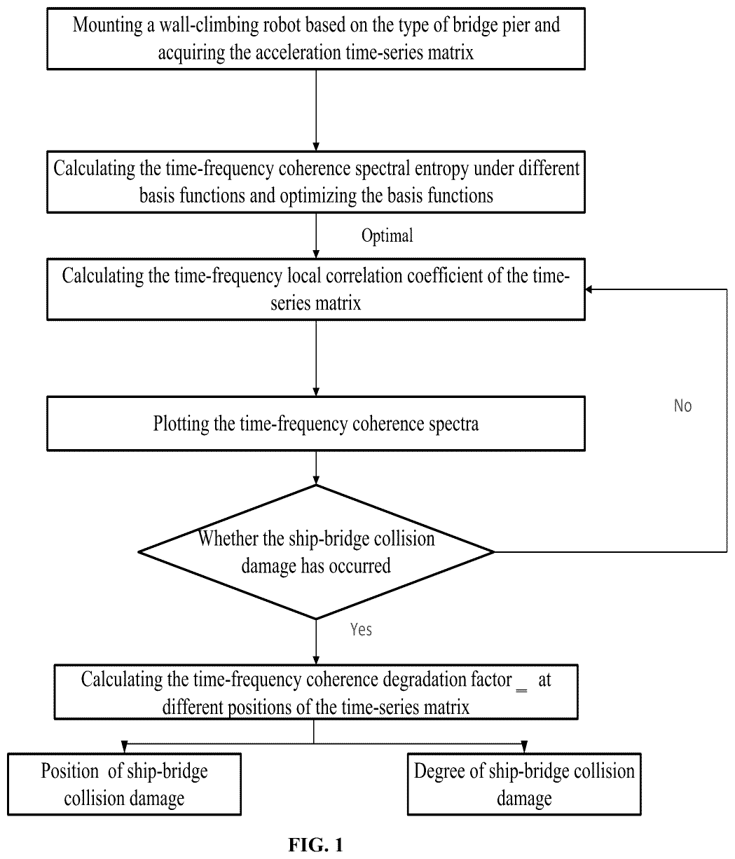

A method for assessing bridge damage triggered by ship impact is provided by the present disclosure, and the specific process is shown in FIG. 1, including the following steps:
S1: the acceleration response signal arrays at different heights and positions of bridge piers impacted by ships are acquired, and the time-series matrix of acceleration response signals is generated based on the acceleration response signal arrays;
S2: the time-frequency coherence spectra under different basis functions are plotted according to the time-series matrix, and the coherence spectral entropy is obtained; based on the information entropy principle, the optimal basis function is determined by measuring the information volume of time-frequency coherence spectra in different basis function domains according to coherence spectral entropy;
S3: the local correlation coefficients of the time-series matrix in the time-frequency domain under the optimal basis function are obtained, and the time-frequency coherence spectra are plotted; the correlation dependence degree between time series is evaluated based on the local correlation coefficients and time-frequency coherence spectra to determine whether ship-bridge collision damage has occurred; and
S4: if the ship-bridge collision damage has occurred, the time-frequency coherence degradation factors at different positions of the time-series matrix are calculated, and the trajectory curve of time-frequency coherence degradation factors is plotted; the impact damage position and the damage degree are determined based on the convex maximum point in the trajectory curve of the time-frequency coherence degradation factors.

Specifically, in S1, the step of acquiring acceleration response signal arrays at different heights and positions of the bridge impacted by the ship includes the following steps:
the wall-climbing robot is mounted according to characteristics of the target pier to be tested; the wall-climbing robot is composed of multiple acceleration sensors, climbing units and control units. If the number of sensors is sufficient for coverage, a digital skin examination can be established by a vertical scanning using the wall-climbing robot.

The wall-climbing robot is driven to scan the pier by moving from top to bottom or from bottom to top, the acceleration response signal arrays at different heights and positions of the pier are acquired through the acceleration sensors, and the time-series matrix is generated.

Further, in S1, the time-series matrix is shown as follows:

$$H = [ \begin{matrix}{X}_{11} & … & {X}_{1 n} \\ ⋮ & ⋱ & ⋮ \\ {X}_{m 1} & … & {X}_{mn}\end{matrix} ] , {X}_{ij} = [ {x}_{1} {x}_{2} … {x}_{l} ]$$

where m is the total number of the set pier sensor layers, 1≤i≤m; n is the total number of array sensors in each layer, and 1≤j≤n; l is the total length of the acquisition time series.

Further, in S3, the calculation of the local correlation coefficients is as follows:

$${R}^{2} ( a , b ) = \frac{{\vert S ( {W}^{{X}_{ij} {X}_{ik}} ( a , b ) ) \vert}^{2}}{[ {\vert S ( {W}^{{X}_{ij}} ( a , b ) ) \vert}^{2} \times {\vert S ( {W}^{{X}_{ik}} ( a , b ) ) \vert}^{2} ]}$$

in the formula, R²(a, b) is the time-frequency local correlation coefficient between two series, S is the smoothing operator, W^{X}^{ᵢⱼ}(a, b) and W^{X}^{ᵢₖ}(a, b) are wavelet coefficients of time series Xᵢⱼ and Xᵢₖ respectively, a is the scale factor of time-frequency transform, and b is the translation factor;
in the formula, when j≠k, W^{X}^{ᵢⱼ}^{X}^{ᵢₖ}(a, b) is the cross wavelet transform function for the time series Xᵢⱼ and Xᵢₖ, |W^{X}^{ᵢⱼ}^{X}^{ᵢₖ}(a, b)| represents its cross wavelet power; when j=k, W^{X}^{ᵢⱼ}^{X}^{ᵢₖ}(a, b) is the autocorrelation wavelet transform function for the time series Xᵢⱼ and Xᵢₖ, as shown in the following formula:

$${W}^{{X}_{ij} {x}_{ik}} ( a , b ) = {W}^{{X}_{ij}} ( a , b ) {( {W}^{{X}_{i k}} ( a , b ) )}^{*}$$

in the formula, * is the complex conjugate.

Specifically, the wavelet function is used as the basis function to calculate the undetermined wavelet coefficients W^{H}^{ᵢⱼ}(a, b) and W^{H}^{ᵢₖ}(a, b) in the time-frequency coherence values R²(a, b) between time series, as shown in the following formula:

$$W ( a , b ) = \frac{1}{\sqrt{a}} {\int }_{- ∞}^{+ ∞} {X}_{ij} ψ ( \frac{t - b}{a} ) dt$$

In the formula, ψ is the selected wavelet basis function.

Further, in S2, the calculation of the coherence spectral entropy includes the following steps:
the time-frequency coherence spectra are divided into N time-frequency planes with the same area, the number ζ_{w} of the correlation coefficient in each time-frequency plane passing the 95% significance test, (W=1, . . . , N), and the total number A of the whole time-frequency coherence spectra passing the 95% significance test, and each region is normalized to obtain:

$${q}_{w} = \frac{{ζ}_{w}}{A} , {\sum }_{w = 1}^{N} {q}_{i} = 1$$

based on the concept of information entropy, the coherence spectral entropy H_{c} of the time-frequency coherence spectra is calculated by using the following formula:

$${H}_{c} = - {\sum }_{w = I}^{N} {q}_{w} {log}_{2} ( {q}_{w} )$$

where the coherence spectral entropy H_{c} represents the intrinsic information quantity of the time-frequency coherence spectra, if the entropy value is greater, it indicates that the information quantity included in the time-frequency coherence spectra is greater, and the information value of the time-frequency coherence spectra is higher.

Further, in S4, the calculation of the time-frequency coherence degradation factor includes the following steps:
the time-frequency coherence degradation factor ∈ is defined as follows:

$$∈ = ( {AWC}_{Intact} - {AWC}_{Input} ) / {AWC}_{Intact}$$

in the formula, AWC_{Intact} refers to the mean of the time-frequency coherence value of the undamaged structure in the certain time-frequency range; AWC_{Input} refers to the mean of the time-frequency coherence value of the structure to be tested in the certain time-frequency range.

Further, in S4, the step of determining the impact damage position and the damage degree based on the convex maximum point in the trajectory curve of the time-frequency coherence degradation factors, including the following steps:
based on the local correlation coefficient of the time-series matrix in the time-frequency domain, the coherence of the time series at the 95% significance level is calculated by using the Monte Carlo method, and the time-frequency coherence spectra are plotted;
wherein the time-frequency coherence spectra fluctuate in a certain time-frequency range, and when the fluctuation degree cannot be restored to stability, it is determined that the ship-bridge collision damage occurs, where the fluctuation degree is represented by the ratio of the number passing the 95% significance tests to the total number in the time-frequency coherence spectra.

Based on variation characteristics of the time-frequency coherence degradation factor at the impact damage position, the trajectory curve of the time-frequency coherence degradation factor is plotted, when bridge collision damage occurs, the time-frequency coherence degradation factor increases dramatically close to the impact damage position, while the degradation factor is nearly zero far from the impact damage position. It is considered that the layer where the convex maximum value of the curve located is the impact damage position. Meanwhile, with the deepening of bridge damage, the time-frequency coherence degradation factor increases significantly, which can effectively identify the position and degree of ship-bridge collision damage.

In this embodiment, the feasibility of the present disclosure is verified by performing the response analysis of the pier under the ship impact:
S1: the numerical model of the bridge pier structure is constructed, the finite element model sizes of the pier structure are length (L=6 m), width (W=3 m), height (H=16 m), the bottom is fixed and the top is free.
S2: according to the characteristics of ship-bridge collision damage, the damage is set as a breathing crack.

The state of the crack in the structure is related to the stress of the crack. In general, the crack is not constantly in an open state, but a nonlinear behavior of periodic opening and closing with the vibration of the structure. The opening and closing behavior of breathing cracks is typically considered as the contact problem between surfaces at the position of structural cracks, that is, surface-to-surface contact can be used to define its behavior.

In surface-to-surface contact, the target surface is allowed to penetrate the contact surface, but the contact surface is not allowed to penetrate the target surface. During the vibration of the pier structure, there are three states of the breathing crack, which are a completely opening state (no contact of the node), a transition state (partial contact of the node), and a completely closing state (complete contact of the node).
S3: the crack is located at a height of h=4.5 m from the bottom of the pier. The crack length is set to a, the crack width is set to b, and no expansion occurs. In order to facilitate the definition of damage degree, the damage degree is defined as:

$$p = \frac{a}{L}$$

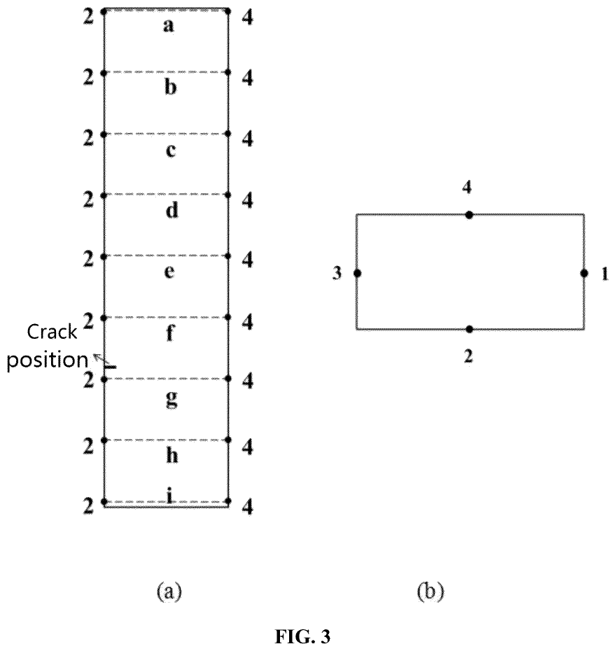

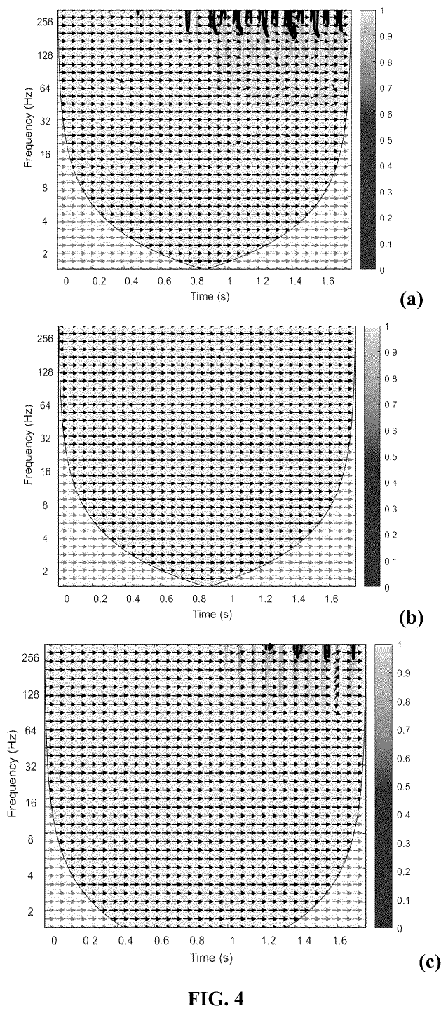

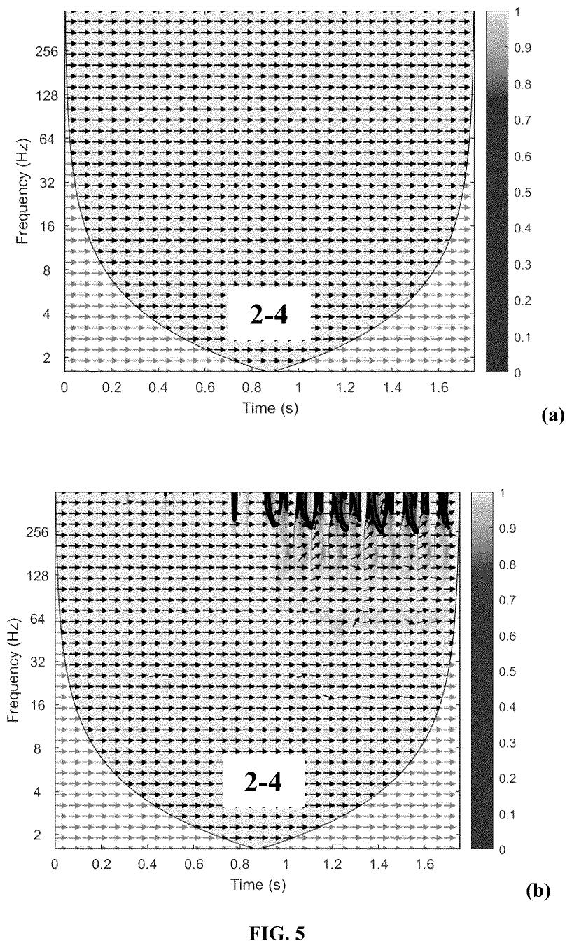

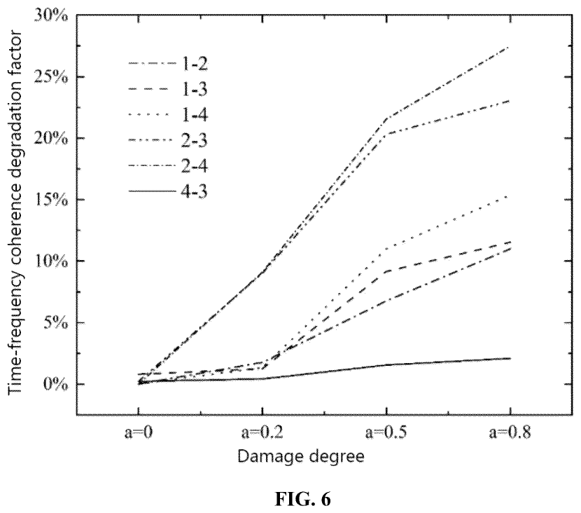

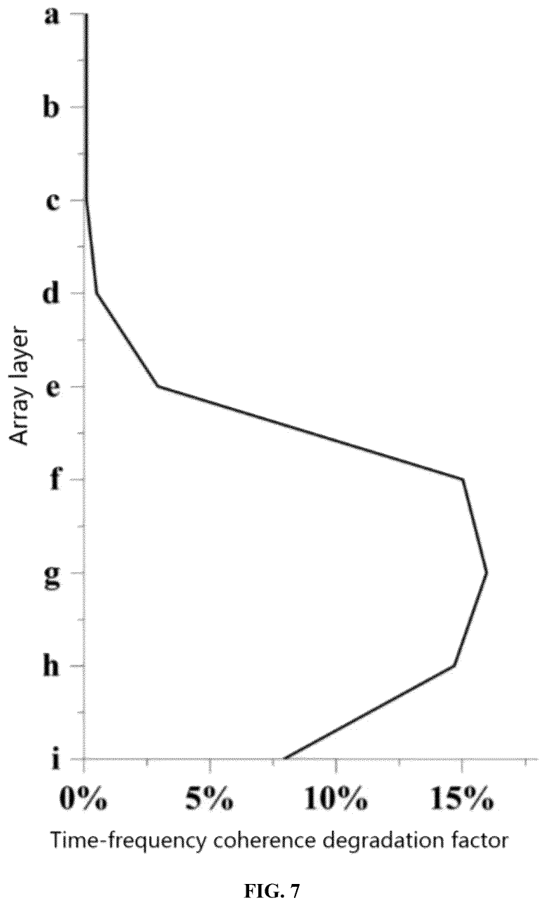

in the formula, p is the relative depth of the crack, a is the crack length, and L is the pier length. Three kinds of damage degrees are set, which are p=0.2, p=0.5, and p=0.8, and the undamaged pier structure is set as the control.
S4: a uniform force F is applied in the area near the crack position, where F is the ship-bridge impact force obtained during the ship-bridge collision simulation.
S5: the wall-climbing robot is mounted on the target pier, and the sensor acquisition device is arranged on each side of the pier, that is, the acceleration response of symmetrical nodes 1, 3, 2 and 4 is acquired at each height. The wall-climbing robot moves from top to bottom, and the distance is acquired once at an interval of 2 m. The positions of different heights are defined as a, b, c, . . . , i, a total of 9 height positions, and a 9*4 acceleration time-series matrix H is constructed. The sensor acquisition position is shown in FIG. 3.
S6: the symmetric nodes 2 and 4 at the height position f are taken as examples, the time-frequency coherence spectra of the two node sequences under different basis functions are plotted, and the coherence spectral entropy H_{c} is calculated respectively, as shown in FIG. 4, where FIG. 4(a) is a Morlet wavelet basis function, and the coherence spectral entropy is 10.6157; FIG. 4(b) is a Dog wavelet basis function, and the coherence spectral entropy is 6.8329; FIG. 4(c) is a 4th-order Paul wavelet basis function, and the coherence spectral entropy is 8.2761. It can also be observed from the diagram that (a) has more fluctuation information than (b) and (c), the fluctuation information is also important information for determining the ship-bridge collision damage. Accordingly, the optimal basis function is selected to calculate the local coefficients of the time series in the time-frequency domain.
S7: the symmetrical nodes 2 and 4 are taken as examples, the local correlation coefficient of time series in time-frequency domain under the optimal basis function is calculated, and the time-frequency coherence spectra are plotted. As shown in FIG. 5, FIG. 5(a) is an undamaged pier structure, and FIG. 5(b) is a damaged pier structure. In the case of no damage to the pier structure, the time-frequency coherence spectrum has no fluctuation, and the time-frequency local correlation coefficient is 1. In contrast, the time-frequency coherence spectrum of the damage situation fluctuate periodically in a certain time-frequency range, which is caused by the nonlinear behavior of the breathing crack during the vibration of the pier. Based on this, the method can clearly determine the occurrence of ship-bridge collision damage.
S8: if it is determined that the ship-bridge collision damage has occurred, the time-frequency coherent degradation factor ∈ is calculated, and the trajectory curve of the degradation factor is plotted. It can be seen from FIG. 6 and FIG. 7 that the time-frequency degradation factor is almost 0 under the condition of no damage. With the increase of crack degree, the fluctuation degree of time-frequency coherence spectra deepens, and the time-frequency degradation factor between different nodes gradually increases, which can effectively describe the degree of ship-bridge collision damage. The impact damage position can be accurately identified by the highlight of the degradation factor trajectory curve at different heights.

Additionally provided is a method of monitoring, scheduling, inspecting, assessing and repairing bridge damage of bridge structures in areas susceptible to ship impacts, comprising monitoring bridges for ship impacts by the methods set forth herein, identifying ship impact events, deploying inspection and repair crews, and repairing bridge damage events identified by the disclosed method.

The above embodiments verify the effectiveness of the present disclosure in identifying ship-bridge collision damage characteristics, providing a fundamental methodological basis for establishing ship-bridge collision damage assessment technology.

The above describes a method for assessing bridge damage triggered by ship impact provided by this embodiment. Based on the same concept, this embodiment further provides a corresponding system for assessing bridge damage triggered by ship impact. The specific limitations of the system for assessing bridge damage triggered by ship impact can be referenced from the limitations described above for the method for assessing bridge damage triggered by ship impact, and will not be repeated here. The various modules in the aforementioned bridge damage assessment system triggered by ship impacts may be implemented entirely or partially through software, hardware, or a combination thereof. These modules may be embedded in or independent of the processor within a computer device in hardware form, or stored in the memory of a computer device in software form, enabling the processor to execute the corresponding operations of each module.

This embodiment further provides a computer-readable storage medium, wherein the storage medium stores a computer program, and the computer program is used to execute a method for assessing bridge damage triggered by ship impact as provided in FIG. 1 above.

Those skilled in the art will understand that all or part of the processes in the above embodiments can be performed by a computer program instructing the related hardware. The computer program can be stored in a non-volatile computer-readable storage medium, and when the computer program is executed, it can include the processes of the embodiments of the above methods. In the embodiments provided in the present application, any reference to memory, storage, databases, or other media may include at least one non-volatile and volatile storage. Non-volatile storage may include read-only memory (ROM), magnetic tape, floppy disks, flash memory, or optical storage, among others. Volatile storage may include random access memory (RAM) or external high-speed cache memory. For illustration rather than limitation, RAM may take various forms, such as static random access memory (SRAM) or dynamic random access memory (DRAM), etc.

The above examples are merely preferred embodiments of the present disclosure, but not intended to limit the present disclosure, and any modifications, equivalent replacements, improvements, etc. made within the spirit and principles of the disclosure should fall within the scope of protection of the present disclosure.

What is claimed is:

1. A method for assessing bridge damage triggered by ship impact, comprising the following steps:
acquiring acceleration response signal arrays at different heights and positions of bridge piers impacted by ships, and generating a time-series matrix of acceleration response signals based on the acceleration response signal arrays;
plotting time-frequency coherence spectra under different basis functions according to the time-series matrix, and obtaining coherence spectral entropy; based on an information entropy principle, determining an optimal basis function by measuring an information volume of time-frequency coherence spectra in different basis function domains according to the coherence spectral entropy;
obtaining local correlation coefficients of the time-series matrix in the time-frequency domain under the optimal basis function, and plotting the time-frequency coherence spectra; evaluating a correlation dependence degree between time series based on the local correlation coefficients and time-frequency coherence spectra to determine whether ship-bridge collision damage has occurred; and
if the ship-bridge collision damage has occurred, calculating time-frequency coherence degradation factors at different positions of the time-series matrix, plotting a trajectory curve of time-frequency coherence degradation factors; and determining an impact damage position and a damage degree based on a convex maximum point in the trajectory curve of the time-frequency coherence degradation factors.

2. The method for assessing bridge damage triggered by ship impact according to claim 1, wherein the step of acquiring acceleration response signal arrays at different heights and positions of the bridge impacted by the ship comprises the following steps:
mounting a wall-climbing robot according to characteristics of a target pier to be tested, wherein each side of the wall-climbing robot facing the pier is provided with at least one acceleration sensor at equal intervals; and
driving the wall-climbing robot to scan the pier by moving from top to bottom or from bottom to top, acquiring acceleration response signal arrays at different heights and positions of the pier through the acceleration sensors, and generating the time-series matrix.

3. The method for assessing bridge damage triggered by ship impact according to claim 2, wherein the time-series matrix is shown as follows:
$$H = [ \begin{matrix}{X}_{11} & … & {X}_{1 n} \\ ⋮ & ⋱ & ⋮ \\ {X}_{m 1} & … & {X}_{mn}\end{matrix} ] , {X}_{ij} = [ {x}_{1} {x}_{2} … {x}_{l} ]$$
where m is a total number of the set pier sensor layers, 1≤i≤m; n is a total number of array sensors in each layer, and 1≤j≤n; l is a total length of the acquisition time series.

4. The method for assessing bridge damage triggered by ship impact according to claim 1, wherein the calculation of the local correlation coefficients is performed as follows:
$${R}^{2} ( a , b ) = \frac{{\vert S ( {W}^{{X}_{ij} {X}_{ik}} ( a , b ) ) \vert}^{2}}{[ {\vert S ( {W}^{{X}_{ij}} ( a , b ) ) \vert}^{2} \times {\vert S ( {W}^{{X}_{ik}} ( a , b ) ) \vert}^{2} ]}$$
in the formula, R²(a, b) is a time-frequency local correlation coefficient between two series, S is a smoothing operator, W^{X}^{ᵢⱼ}(a, b) and W^{X}^{ᵢₖ}(a, b) are wavelet coefficients of time series Xᵢⱼ and Xᵢₖ respectively, a is a scale factor of time-frequency transform, and b is a translation factor;
in the formula, when j≠k, W^{X}^{ᵢⱼ}^{X}^{ᵢₖ}(a, b) is a cross wavelet transform function for the time series Xᵢⱼ and Xᵢₖ, |W^{X}^{ᵢⱼ}^{X}^{ᵢₖ}(a, b)| represents its cross wavelet power; when j=k, W^{X}^{ᵢⱼ}^{X}^{ᵢₖ}(a, b) is an autocorrelation wavelet transform function for the time series Xᵢⱼ and Xᵢₖ, as shown in the following formula:
$${W}^{{X}_{ij} {x}_{ik}} ( a , b ) = {W}^{{X}_{ij}} ( a , b ) {( {W}^{{X}_{i k}} ( a , b ) )}^{*}$$
in the formula, * is a complex conjugate.

5. The method for assessing bridge damage triggered by ship impact according to claim 4, wherein the calculation further comprises:
using the wavelet function as the basis function to calculate the undetermined wavelet coefficients W^{H}^{ᵢⱼ}(a, b) and W^{H}^{ᵢₖ}(a, b) in the time-frequency coherence values R²(a, b) between time series, as shown in the following formula:
$$W ( a , b ) = \frac{1}{\sqrt{a}} {\int }_{- ∞}^{+ ∞} {X}_{ij} ψ ( \frac{t - b}{a} ) dt$$
in the formula, ψ is a selected wavelet basis function.

6. The method for assessing bridge damage triggered by ship impact according to claim 5, wherein the calculation of the coherence spectral entropy comprises the following steps:
dividing the time-frequency coherence spectra into N time-frequency planes with the same area, a number ζ_{w} of the correlation coefficients in each time-frequency plane passing the 95% significance test, (W=1, . . . , N), and the total number A of the whole time-frequency coherence spectra passing the 95% significance test, and normalizing each region to obtain:
$${q}_{w} = \frac{{ζ}_{w}}{A} , {\sum }_{w = 1}^{N} {q}_{i} = 1$$
based on a concept of information entropy, calculating the coherence spectral entropy H_{c} of the time-frequency coherence spectra by using the following formula:
$${H}_{c} = - {\sum }_{w = 1}^{N} {q}_{w} {log}_{2} ( {q}_{w} )$$
where the coherence spectral entropy H_{c} represents an intrinsic information quantity of the time-frequency coherence spectra, if the entropy value is greater, it indicates that the information quantity comprised in the time-frequency coherence spectra is greater, and an information value of the time-frequency coherence spectra is higher.

7. The method for assessing bridge damage triggered by ship impact according to claim 1, wherein the calculation of the time-frequency coherence degradation factor comprises the following steps:
defining the time-frequency coherence degradation factor ∈ as follows:
$$∈ = ( {AWC}_{Intact} - {AWC}_{Input} ) / {AWC}_{Intact}$$
in the formula, AWC_{Intact} refers to a mean of the time-frequency coherence value of the undamaged structure in a certain time-frequency range; AWC_{Input} refers to a mean of the time-frequency coherence value of the structure to be tested in a certain time-frequency range.

8. The method for assessing bridge damage triggered by ship impact according to claim 1, wherein the step of determining the impact damage position and the damage degree based on the convex maximum point in the trajectory curve of the time-frequency coherence degradation factors comprises the following steps:
based on the local correlation coefficient of the time-series matrix in the time-frequency domain, calculating a coherence of the time series at a 95% significance level by using a Monte Carlo method, and plotting the time-frequency coherence spectra;
wherein the time-frequency coherence spectra fluctuate in a certain time-frequency range, and wherein, when a fluctuation degree cannot be restored to stability, it is determined that the ship-bridge collision damage has occurred, wherein the fluctuation degree is represented by a ratio of a number passing the 95% significance test to the total number in the time-frequency coherence spectra;
based on variation characteristics of the time-frequency coherence degradation factor at the impact damage position, plotting the trajectory curve of the time-frequency coherence degradation factor, wherein, when bridge collision damage occurs, the time-frequency coherence degradation factor increases dramatically close to the impact damage position, whereas, while the time-frequency coherence degradation factor is nearly zero far from the impact damage position, the layer where the convex maximum value of the curve is located is the impact damage position.

9. A system for assessing bridge damage triggered by ship impact, wherein the system comprises:
a processor; and
a memory, a computer program executable on the processor is stored on the memory;
wherein, when the computer program is executed by the processor, the steps of the method for assessing bridge damage triggered by ship impact according to claim 8 is implemented.

10. A computer-readable storage medium, wherein a data processing program is stored on the computer-readable storage medium, when the data processing program is executed by the processor, the steps of the method for assessing bridge damage triggered by ship impact according to claim 8 is implemented.
